(19) United States
(12) Patent Application Publication
(10) Pub. No.: US 2025/0065591 A1
(43) Pub. Date: Feb. 27, 2025

(54) APPARATUS HAVING AN ELECTRIC MOTOR FOR PROVIDING PACKAGING MATERIAL AND METHOD FOR OPERATING A PACKAGING MATERIAL PROVISION APPARATUS

(71) Applicant: Sprick GmbH Bielefelder Papier- und Wellpappenwerke & Co., Bielefeld (DE)

(72) Inventors: Marco Schwarberg, Melle (DE); Bastian Schalk, Detmold (DE); Vitali Krebs, Ahlen (DE)

(73) Assignee: Sprick GmbH Bielefelder Papier- und Wellpappenwerke & Co., Bielefeld (DE)

(21) Appl. No.: 18/947,775

(22) Filed: Nov. 14, 2024

Related U.S. Application Data
(62) Division of application No. 17/413,307, filed on Jun. 11, 2021.

(30) Foreign Application Priority Data
Dec. 11, 2018 (DE) 102018009733.2

(51) Int. Cl. B31D 5/00

(52) U.S. Cl. CPC B31D 5/0052; B31D 2205/0023; B31D 2205/0047; B31D 2205/0058; B31D 2205/0082; B31D 2205/0088

(57) ABSTRACT

An apparatus for providing packaging material (e.g. a corrugated board web section or a paper cushioning material strand) by manipulating (e.g. deforming, conveying and/or separating) a fiber starting material (e.g. a single or multi-ply paper web or a corrugated board web) may include at least one working device to be driven mechanically by at least one electric motor having a stationary stator and a rotor mounted movably thereto. An excitation current may be applied to a coil arrangement of the rotor or of the stator. The motor may be free of an electrical contact coupling for transmitting the excitation current between the stator and the rotor, and may include a detector to detect the position of the rotor. The working device may be a deformation device (e.g. a pair of deformation wheels), a conveyor (e.g. a pair of conveyor wheels), or a separating device (e.g. a rotary or translational cutter).

### CROSS REFERENCE TO RELATED APPLICATIONS

This patent application is divisional patent application of U.S. application Ser. No. 17/413,307, filed Jun. 11, 2021, which is a U.S. National Stage application of International Application No. PCT/EP2019/084675, filed on Dec. 11, 2019, which claims priority to German Patent Application No. 102018009733.2, filed Dec. 11, 2018. Each of these applications is incorporated by reference in its entirety.

### BACKGROUND

### Field

The disclosure relates to an apparatus with an electric motor for providing packaging material, such as a corrugated board web section or a paper cushioning material strand, in particular made of recycled paper. Furthermore, the disclosure relates to a method for operating a packaging material providing apparatus.

### Related Art

Apparatuses of this category are set up, for example, in logistics centers as movable, mobile units in order to provide length-converted packaging material when packaging an object. As packaging material, for example, a paper cushioning strand can be provided, which is obtained from a single-ply or multi-ply paper web, in particular from recycled paper, in the form of a material web roll or a zigzag-folded packaging material stack, also referred to as a fanfold stack, which saves space compared to the paper cushioning strand. To produce the paper cushioning strand, the paper web is pulled from a roll or fanfold stack and formed in such a way that air pockets are formed to provide cushioning between the item to be packaged and the outer packaging. After the deformation of the paper web into a three-dimensional paper cushioning strand, a paper cushioning product, in particular of a certain length, can be separated from the paper cushioning strand. However, packaging material can also be provided in the form of corrugated board web sections which are conveyed from a corrugated board web, in particular in the form of a fanfold stack, and are then preferably cut off into length-converted sections. For reasons of sustainability, corrugated board web sections are also preferably made from recycled paper.

DE 10 2016 114 342 A1 discloses a packaging material provision apparatus with two electric motors each of which drives a drive roller of the apparatus and is controlled via a controller. The use of such an apparatus enables a greater production capacity compared to purely manually operated apparatuses. However, the additional components required for this, such as the electric motor and a controller connected to the electric motor, also entail additional risks of failure of the apparatus. For example, electric motors are subject to wear, so that they have to be replaced after a certain service life.

Furthermore, in the event of a clogging of the device, the electric motor or the controller may overheat, which may lead to a failure of the apparatus. Especially when producing packaging material from recycled paper, there is also an increased risk of clogging, since recycled paper has shorter fibers compared to paper material containing fresh fibers, which lead to increased dust and shred formation when the paper is cut or torn, which in turn can promote the occurrence of clogging. Furthermore, the increased dust and shred formation in combination with the use of an electric motor poses an increased risk of fire, especially if the electric motors overheat.

In addition, the use of electric motors entails an increased development effort for new apparatuses designed in each case for specific materials and shapes of a packaging material. Thus, normally, the controller must be designed according to the number and type of electric motors used. This leads to increased development times and development costs for the apparatus.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 a bottom view of an apparatus according to an exemplary embodiment with the lower and upper boundary walls removed to illustrate the individual components and the blade being in a cutting start position;

FIG. 2 a perspective top view of the apparatus of FIG. 1, with the blade being in a cutting end position;

FIG. 3 a perspective bottom view of the apparatus of FIG. 1, with the blade being in the cutting end position;

FIG. 4 a second perspective bottom view of the apparatus of FIG. 1, with the blade being in the cutting end position;

FIG. 5 a schematic representation of the connection between a higher-level controller, two lower-level sub-controllers and two electric motors via a communication link, according to an exemplary embodiment;

FIG. 6 a schematic representation of example connections between electric motor and controller;

FIG. 7 a schematic illustration of a system according to an exemplary embodiment;

FIG. 8 a schematic illustration of a system according to an exemplary embodiment; and

FIG. 9 a schematic diagram of the connection of a higher-level controller, a communication link, three electric motor-own sub-controllers, three electric motors, and a position detector and three working devices, according to an exemplary embodiment.

The exemplary embodiments of the present disclosure will be described with reference to the accompanying drawings. Elements, features and components that are identical, functionally identical and have the same effect are-insofar as is not stated otherwise-respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure. The connections shown in the figures between functional units or other elements can also be implemented as indirect connections, wherein a connection can be wireless or wired. Functional units can be implemented as hardware, software or a combination of hardware and software.

It is an object of the disclosure to overcome the disadvantages of the prior art, in particular to provide an apparatus for providing packaging material and a method for operating a packaging material provision apparatus, in which the service life of the electric motor is increased, the risk of failure, for example due to overheating or fire, is reduced and/or the development times or costs for the development of packaging material provision apparatuses, in particular of their controllers, are reduced.

The disclosure relates to an apparatus for providing packaging material, such as a corrugated board web section or a paper cushioning material strand, by manipulating, in particular deforming, conveying and/or separating, a fiber starting material, such as a single-ply or multi-ply paper web or a corrugated board web. According to a first aspect of the present disclosure, the apparatus comprises at least one working device to be mechanically driven, such as a deformation device (deformer), in particular a pair of deformation wheels, a conveying device (conveyor), in particular a pair of conveying wheels, or a separating device (separator, cutter), in particular a rotary cutter or a translational cutter. Furthermore, the apparatus comprises at least one electric motor driving the working device and having a stationary stator, a rotor mounted movably thereto, and a coil arrangement of the rotor or of the stator to which an excitation current is applied. According to the first aspect of the present disclosure, the electric motor is free of an electrical contact coupling for transmitting the excitation current between the stator and the rotor. Further, the electric motor comprises means for sensing the position of the rotor.

The packaging material is made in particular from recycled paper. Recycled paper is in particular paper materials with a low proportion (less than 50%) of fresh fiber-containing paper material. In particular, paper materials containing 70% to 100% recycled paper are preferred. The recycled paper in the sense of the present disclosure is intended to be paper material that can have a tensile strength index along the machine direction of at most 90 Nm/g, preferably a tensile strength of 15 Nm/g to 60 Nm/g and a tensile strength index across the machine direction of at most 60 Nm/g, preferably a tensile strength of 5 Nm/g to 40 Nm/g. A DIN EN ISO 1924-2 or DIN EN ISO 1924-3 standard can be used to determine the tensile strength or tensile strength index. Additionally, or alternatively, a recycled paper property or recovered paper property can be characterized by the so-called bursting resistance. A material in this sense is recycled paper with a burst index of at most 3.0 kPa*m\hat{ }2/g, preferably with a burst index of 0.8 kPa*m\hat{ }2/g to 2.5 kPa*m\hat{ }2/g. The DIN EN ISO 2758 standard is used to determine the burst index. Furthermore, the packaging material has a surface-specific weight of, in particular, 40 g/m\hat{ }2 to max. 140 g/m\hat{ }2. In particular, the fiber starting material can be a single-ply or multi-ply paper web or a corrugated board web. Furthermore, the fiber starting material can be present as a material web roll or as a zigzag-folded packaging material stack, which is also referred to as a fanfold stack.

The difference between fiber starting material and packaging material can be, in particular, that the fiber starting material is present, for example, as a material web roll or as a packaging material stack, whereas the packaging material is a material section conveyed off the material web roll or the packaging material stack. In this case, the manipulation of the fiber starting material may already lie in the conveying of a material section from the material web roll or the packaging material stack. However, manipulation may also be understood to be, in particular, the severing of a section of packaging material from a material web. For example, the manipulation may be the severing of a packaging material product from a packaging material strand. Further, the manipulation may particularly comprise deforming the fiber starting material. For example, the manipulation may consist of deforming a single or multi-layer paper web into a three-dimensional paper cushioning strand. Conveying, severing, and forming may alone or in combination constitute the manipulation of the fiber starting material. A particularly preferred form of manipulation involves first deforming a single or multi-ply paper web into a three-dimensional paper cushioning strand, and then separating a paper cushioning product from the paper cushioning strand. Alternatively, a form of manipulation is to convey a corrugated board web section from a corrugated board web and then preferably separate the conveyed corrugated board web section from the remaining corrugated board web.

In particular, the apparatus described in connection with the first and/or second aspect of the present disclosure may be a packaging material provision apparatus. In particular, a packaging material provision apparatus provides packaging material by manipulating fiber starting material. As described previously and hereinafter, the manipulation of the fiber starting material may include, individually or in combination, both conveying, separating, and/or deforming the fiber starting material. In an exemplary embodiment, however, the manipulation comprises at least separating or deforming fiber starting material. In applications or embodiments in which the manipulation comprises exclusively conveying the fiber starting material, the conveying particularly comprises conveying the fiber starting material from a material web roll or from a packaging material stack. Particularly preferably, the apparatus described in connection with the first and/or second aspect of the present disclosure relates to a packaging material generating apparatus. In particular, a packaging material generating apparatus is an apparatus in which the manipulation comprises at least one of deforming and/or separating the fiber starting material. More particularly, the apparatus described in connection with the first and/or second aspect of the present disclosure relates to a cushioning material generating apparatus. In particular, a cushioning material generating apparatus refers to an apparatus in which the manipulation comprises a deforming operation in which a three-dimensional cushioning strand, in particular a three-dimensional paper cushioning strand, is generated from a single-ply or multi-ply web of starting material, in particular from a single-ply or multi-ply paper web.

For the manipulation of the fiber starting material, in particular one of the mentioned working devices can be used. In addition, however, a deformation device, such as a deformation funnel, can also be used for the manipulation, into which the fiber starting material is conveyed by a working device, such as a conveyor device.

An excitation current can be applied to the coil arrangement to drive the working device. The coil arrangement can in principle be formed on the rotor or on the stator, whereby the formation on the stator is preferred. The coil arrangement preferably comprises at least three coils to which the excitation current can be applied alternately to generate a rotating field that causes the rotor to rotate. For this purpose, the rotor preferably has a permanent magnet, in particular a permanent magnet with at least one, two, three, four or more pairs of poles. By the electric motor being free of a contact coupling between the stator and the rotor, the wear of the electric motor can be reduced, for example compared to brush motors, and thus the service life of the device can be increased. The position detector allows the position of the rotor to be determined and thus the coil arrangement to be controlled according to the rotor position without having to use electrical contact coupling, such as brushes, between the stator and the rotor. At the same time, the position detector makes it possible in particular to specify the position of the rotor accurately down to the resolution of the electric motor. The resolution of the electric motor results in particular from the product of the pole pairs and the coils. For an electric motor with four pole pairs and three coils, this results in a resolution of 24, so that the rotor position can be detected accurate up to 15°.

In a preferred embodiment, the at least one electric motor is a brushless DC motor or a stepper motor. Alternatively, or additionally, the at least one electric motor is a permanently excited motor and/or a synchronous motor. In general, the motor according to the disclosure may be a single-phase motor, such as a Lavet stepper motor, an AC squirrel-cage motor or a split-phase motor, a two-phase motor, such as a two-phase stepper motor, or a three-phase motor, such as a brushless DC motor or a three-phase asynchronous motor. However, the design of a brushless DC motor with a permanent magnet as rotor, in particular with two, three, or four pole pairs and a stator with a coil arrangement, preferably of three coils, is particularly advantageous. However, in the case of using stepper motors, it may also be preferred to use a rotor with at least 10, 30 or 50 pole pairs and a stator with two, three or four coils.

In a preferred embodiment, the position detector has at least one, preferably three, in particular electromagnetic sensors, such as a Hall sensor, a resolver or a line encoder, for measuring a signal induced by the rotary motion of the rotor. In an exemplary embodiment, the signal is generated by rotation of the rotor by a predetermined angle, particularly preferably by 10° to 60°, 20° to 50° or 30° to 40°. In the less advantageous embodiment using a stepper motor, the predetermined angle may be significantly smaller, for example between 1° and 10° or less than 5° or less than 3°.

The predetermined angle particularly depends on to the sensor resolution. In the preferred embodiment with three sensors each offset by 120° to one another and a rotor with four pole pairs respectively eight poles, the sensor resolution is 24. This results in a predetermined angle of at least 15°. The rotary motion of the rotor by 15° or more ensures that at least one sensor undergoes a change from a positive pole to a negative pole in the course of the rotary motion, as a result of which a signal, in particular a voltage, is measured or generated in the sensor. In the preferred embodiment of the brushless DC motor with three coils and four pole pairs, a rotary motion of 15° in particular is already sufficient. However, to ensure a safety factor, a predetermined angle of 30°, for example, can also be provided in this variant. The at least one sensor can be part of the motor, in particular part of a brushless DC motor. Alternatively, the at least one sensor can be designed separately from the motor and preferably be arranged outside the motor.

In an exemplary embodiment, the apparatus has an evaluation device, in particular a controller, such as an electric motor-own controller, which calculates the position of the rotor from at least one signal measured by the position detector. In an exemplary embodiment, the evaluation device is a control electronics, in particular an electric motor-own control electronics, such as a control electronics for brushless DC motors. In an exemplary embodiment, the control electronics are connected to the sensors of the position detector and calculate the position of the rotor from the signal measured by the rotary motion of the rotor. Furthermore, the control electronics are used in particular to control the coil arrangement of the electric motor as a function of the position of the rotor. The evaluation device may be formed separately from the motor, in particular formed on a controller, such as an electric motor-own controller. In an exemplary embodiment, the position detector stores, in particular counts, the measured signal, a reference value or the position of the rotor and calculates therefrom the angle covered by the rotor over a certain period of time, in particular the revolutions covered. This can be realized in particular by means of a counter which counts signals generated by the sensors and, in particular considering the sensor resolution and the resolution of the electric motor, calculates from the number of signals the angle covered by the rotor or the revolutions made. This offers, in particular, the possibility of recording the operating times of the apparatus and thus, for example, being able to better monitor the wear of certain parts or estimate the material consumption, for example of the paper web.

Alternatively, or additionally, the position detector has an evaluation device (evaluator), in particular a controller, such as an electric motor-own controller, for measuring a signal, such as a current and/or a voltage, induced in the coil arrangement by a rotary motion of the rotor. This takes advantage of the fact that the rotary motion of the rotor exerts a generator effect on the coils, which causes a measurable counter voltage in the coils of the coil arrangement. This effect is known in particular as Back EMF. Also, for this embodiment, the evaluation device preferably has control electronics, such as a control of a brushless DC motor, which on the one hand applies a supply voltage to the coil arrangement and on the other hand measures the counter voltage generated in the coils by the rotary motion of the rotor and calculates the position of the rotor on the basis of the measured counter voltage, in particular considering the resolution of the electric motor. The advantage of this embodiment is that the position detector only needs control electronics, thus saving costs for sensors. However, the programming of the control electronics is also more complex. In this embodiment, the position detector and the evaluation device are preferably formed on a common controller, on which they may be arranged on different boards. In an exemplary embodiment, the evaluation device calculates the position of the rotor from the measured signal, preferably stores it, and preferably calculates from it the angle covered by the rotor over a certain period of time, in particular the revolutions covered.

In a further embodiment, in the case of measuring a signal induced by the rotary motion of the rotor, the evaluation device preferably interrogates whether an excitation current is applied to the coil arrangement. Provided that an excitation current is not applied to the coil arrangement, the evaluation device preferably initiates the provision of packaging material by manipulating the fiber starting material. In particular, this embodiment serves to initiate the provision of packaging material by actuating packaging material that has already been manipulated and preferably protrudes from the apparatus. A preferred method used for this purpose is described below in connection with the fifth aspect of the present disclosure. A particularly advantageous feature of this embodiment is that it allows an operator operating the packaging material provision apparatus to remove the already manipulated packaging material from the apparatus and to initiate provision of the next packaging material in one step. The operator can thus devote himself exclusively to the packaging of an object and is automatically provided with new packaging material again and again. By interrogating whether an excitation current is applied to the coil arrangement, it is ensured that, for example, an inadvertent actuation of the packaging material does not unintentionally interrupt an already running provision of packaging material or change it with regard to the process parameters.

In a preferred embodiment, the apparatus comprises a higher-level controller for operating a sub-controller, such as an electric motor-own sub-controller, wherein the sub-controller initiates the provision by manipulation by transmitting a trigger signal to the higher-level controller, whereupon the higher-level controller preferably operates at least one, more preferably two or three, controllers for the provision by manipulation. As previously described, the manipulation of the fiber starting material may comprise several manipulation steps in a row, such as conveying, deforming and separating. In the particularly embodiment, in which a paper cushioning strand is fed from a feed device (feeder) to a separating device, a paper cushioning product is separated from the paper cushioning strand by the separating device, and the paper cushioning product is discharged by a discharge device, three working devices are operated at once. It has therefore proved particularly advantageous to use a higher-level controller which operates the respective working devices via sub-controllers. In an exemplary embodiment, the sub-controllers each control and/or regulate own electric motors, each of which are assigned to a working device. Advantages and further embodiments of the combination of a higher-level controller with at least one sub-controller are explained in particular in connection with the second aspect of the present disclosure.

In an exemplary embodiment, the at least one driven working device is a conveyor device with at least one conveyor wheel that is coupled to the rotor of the electric motor in such a way that a rotary motion of the conveyor wheel causes a rotary motion of the rotor. The coupling preferably comprises a gear, in particular a worm gear, which preferably reduces the rotational speed of the rotor to a rotational speed of the conveyor wheel, in particular with a reduction ratio of 3:2 to 10:1, preferably of 5:1. A particular advantage of the use of a conveyor wheel is that, provided that it is in engagement with the manipulated packaging material, it can be subjected to a rotary movement via simple pulling or pushing of the packaging material, in particular in the conveying direction of the conveyor wheel. This rotary motion can in particular, for example in the case of a direct coupling of the rotor of the electric motor with a drive shaft of the drive wheel, be converted directly into a rotary motion of the rotor. Particularly preferably, however, a gear is connected between the conveyor wheel and the rotor. By reducing the speed of the rotor to the speed of the conveyor wheel, a rotary motion of the conveyor wheel is translated to a larger rotary motion of the rotor. This can ensure that even with small rotary movements of a few degrees, for example of 3°, of the conveyor wheel, in particular by actuating the manipulated packaging material, a sufficient rotary movement of the rotor, in case of a reduction of 5 to 1 of, for example, 15°, is generated to detect it by means of the position detector. In this context, it has proven particularly advantageous to provide a coil arrangement with three coils with a rotor with four pole pairs and the position detector with three sensors, in particular Hall sensors. Particularly preferably, this is combined with a reduction of the rotary motion of the rotor to the conveyor wheel of 5 to 1.

In an exemplary embodiment, the at least one driven working device is a pair of conveyor wheels, wherein at least one conveyor wheel is driven by the electric motor and/or the conveyor wheels are braced against each other. In an exemplary embodiment, the conveyor wheels are braced against each other with a force of at least 10 Newton, 50 Newton, 100 Newton, 150 Newton, 250 Newton, 350 Newton, 450 Newton, 550 Newton, 700 Newton or 900 Newton. Alternatively, or additionally, the wheel axle spacing of the wheels of a respective wheel pair is preferably undersized in such a way that the wheels are elastically braced against each other. A sufficiently high force ensures in particular that the actuation of the packaging material, in particular a pulling on the packaging material, is transmitted to the conveyor wheel in such a way that the conveyor wheel is subjected to a rotational movement, in particular a rotational movement of sufficient magnitude to detect the rotational movement of the rotor.

In an exemplary embodiment, the apparatus has at least two of the working devices to be mechanically driven, preferably one working device being a conveyor device, such as a pair of conveyor wheels, and one working device being a separating device. Alternatively, both working devices can be conveyor devices, such as a pair of feed wheels and a pair of discharge wheels, and preferably a third of the working devices to be driven mechanically is provided, which is a separating device and is particularly preferably arranged in the conveying direction between the two conveyor devices. In an exemplary embodiment, the two, preferably three, working devices are each driven by their own electric motor. This embodiment makes it possible in particular to provide packaging material, in particular in the form of paper cushioning products, with low wear with regard to the electric motors used.

A second aspect of the present disclosure also relates to an apparatus for providing packaging material, such as a corrugated board web section or a paper cushioning material strand, by manipulating, in particular deforming, conveying and/or separating, a fiber starting material, such as a single-ply or multi-ply paper web or a corrugated board web. The apparatus comprises a working device to be driven mechanically, such as a deformation device, in particular a pair of deformation wheels, a conveyor device, in particular a pair of conveyor wheels, or a separating device, in particular a rotary cutter or a translational cutter, and at least one electric motor driving the working device. According to the second aspect of the present disclosure, the apparatus further comprises at least one electric motor-own sub-controller for controlling and/or regulating the electric motor, a higher-level controller for operating the at least one sub-controller, and a communication link for data exchange between the at least one electric motor-own sub-controller and the higher-level controller using BUS technology, such as CAN-BUS technology.

In particular, the embodiments previously and hereinafter described in connection with the first aspect of the present disclosure may be combined with the embodiments previously and hereinafter described in connection with the second aspect of the present disclosure, and vice versa.

The term electric motor-own controller refers in particular to a controller that can drive the electric motor independently. For this purpose, the electric motors-own controller can have its own power supply. In an exemplary embodiment, the electric motor-own sub-controller is configured such that it can drive an electric motor according to the first aspect of the present disclosure. Particularly advantageously, the electric motor-own controller (sub-controller) comprises control electronics particularly capable of driving and/or controlling a brushless DC motor. Furthermore, the electric motor-own sub-controller preferably comprises a frequency converter in order to be able to control and/or regulate the rotational speed, torque, direction of rotation, currents, voltages and/or position of the rotor of the electric motor, in particular of a brushless DC motor. Surprisingly, it has been found that the use of such sub-controllers significantly reduces the development effort for new apparatuses adapted to different types of packaging material to be provided. This is due in part to the fact that the use of electric motor-own sub-controllers reduces the requirements for the higher-level controller. In particular, a uniform higher-level controller can be used that merely sends control commands to the sub-controllers, but the actual control and/or regulation of the electric motors is performed by the sub-controllers. In particular, regardless of whether, for example, a brushed motor or a brushless DC motor is used, the interconnected electric motor-own sub-controller enables to use the same higher-level controller for different apparatuses with different types and numbers of working devices. By standardizing and at the same time reducing the requirements for the higher-level controller, in particular the costs for the latter can be significantly reduced. The development effort for new apparatuses can also be reduced, since, for example, when an electric motor driving a working device is replaced, only the sub-controller of the motor needs to be adapted, but the higher-level controller and any further sub-controllers of possible additional working devices do not need to be redesigned. A further advantage arises, for example, in fire protection, as the electric motor-own sub-controllers can preferably also be used to monitor excitation currents and, in the event of imminent overheating, for example due to packaging material blockages in the device, the system can be switched off automatically.

It should be noted at this point that the sub-controllers do not necessarily have to be assigned to an electric motor. The advantages outlined above also arise with other components, such as with radio modules, such as WLAN modules and Bluetooth modules, with displays, such as displays and touchscreens, with memory modules for storing and retrieving process parameters, such as conveying speed, tension of the material and/or packaging material length, in particular for predetermined packaging materials. In particular, the at least one electric motor-own sub-controller can be supplemented or replaced by at least one sub-controller associated with such components.

In an exemplary embodiment, the communication link uses a BUS technology such as that used by programmable logic controllers. In particular, BUS technology is preferably used via which controllers with different supply voltages, especially with 3.3 volt and/or 5 volt supply voltages, can communicate with each other. Furthermore, the higher-level controller and/or the at least one sub-controller is preferably supplied via a 3.3 volt voltage. This can in particular further increase the compatibility of the controllers, in particular of the higher-level controller.

In one embodiment, the sub-controller measures an excitation current driving the electric motor and interrupts the excitation current when a predefined, permissible current is exceeded, in particular to prevent overheating of the electric motor, the sub-controller and/or the higher-level controller in the event of packaging material blockages in the apparatus. In an exemplary embodiment, the sub-controller can be informed of a permissible excitation current by the higher-level controller. Alternatively, or additionally, the sub-controller can preferably request a permissible excitation current from the higher-level controller. It is also preferred that the sub-controller transmits a corresponding signal to the higher-level controller when an excitation current exceeds the permissible current.

In an exemplary embodiment, the sub-controller has a frequency converter, preferably a single-phase frequency converter with a power supply and a controller. In an exemplary embodiment, each of the sub-controllers used has a frequency converter.

In an exemplary embodiment, the device has a shield, in particular a ferritic shield, which shields the at least one sub-controller from the environment against electromagnetic interference emissions. Alternatively, or additionally, the device has a shield, in particular a ferritic shield, which shields the at least one sub-controller and the higher-level controller and preferably additionally the at least one electric motor from electromagnetic interference emissions. Alternatively, or additionally, the device has a shielding, in particular a ferritic shielding, of the at least one sub-controller, of the at least one electric motor, of the higher-level controller and of the at least one working device, which shields the at least one sub-controller, the at least one electric motor, the higher-level controller and the at least one working device from electromagnetic interference emissions.

In an exemplary embodiment, a ferritic shield may be formed by the housing of the apparatus. In an exemplary embodiment, each sub-controller has a ferritic shield. This is particularly important because the sub-controllers may emit electromagnetic radiation and thereby interfere with each other. In an exemplary embodiment, the ferritic shielding of at least one, preferably of each, sub-controller is in the form of a ferritic coat, for example a sheet metal coat. Particularly when frequency converters are used, adequate shielding is advantageous in order to avoid, as far as possible, mutual interference between the controllers, in particular damage to sensitive elements of the controllers. The degree of shielding can be increased in particular by the measure that, in an exemplary embodiment, each of the sub-controllers has its own ferritic shield and is additionally shielded by a further shield which shields the sub-controllers and the higher-level controller. A ferritic housing surrounding the apparatus can preferably provide further shielding.

The working device can in particular be a separating device for separating the manipulated packaging material, in particular a paper cushioning product from a three-dimensional paper cushioning strand that has been formed in the apparatus from a single-ply or multi-ply paper web or a corrugated board web section from a corrugated board web.

The apparatus preferably further comprises a feed device arranged upstream of the working device in the conveying direction, such as a pair of feed wheels, for conveying the packaging material. Further, the apparatus preferably comprises a second electric motor driving the upstream feed device. In addition, the apparatus preferably comprises a second electric motor-own sub-controller for controlling and/or regulating the second electric motor, wherein the second sub-controller and the higher-level controller are interconnected via the communication link.

In an exemplary embodiment, the apparatus comprises a discharge device arranged downstream of the working device in the conveying direction, such as a pair of discharge wheels, for discharging the packaging material. Further, the apparatus preferably comprises a third electric motor driving the downstream discharge device. In addition, the apparatus preferably comprises a third electric motor-own sub-controller for controlling and/or regulating the third electric motor, the third sub-controller and the higher-level controller being interconnected via the communication link.

Furthermore, it is preferred that the infeed device and the discharge device are each assigned their own electric motor for driving and/or braking the conveying devices independently of one another. In this case, the electric motors are preferably driven in such a way that the infeed device and the discharge device tension the manipulated packaging material, in particular before a paper cushioning product is separated from a three-dimensional paper cushioning strand formed in the apparatus from a single-layer or multilayer paper web. Alternatively, or additionally, the pair of discharge wheels is driven in the opposite direction to the conveying direction when a packaging material blockage occurs.

Furthermore, the present disclosure relates to a method of providing packaging material performed with an apparatus according to the first or second aspect of the present disclosure.

A third aspect of the present disclosure relates to a method for operating a packaging material provision apparatus, in which packaging material, such as a paper cushioning material strand or a corrugated board web section, is provided by manipulating, in particular deforming and/or conveying, a fiber starting material, such as a single-ply or multi-ply paper web or a corrugated board web, wherein the packaging material provision apparatus has at least one working device to be driven mechanically and at least one electric motor driving the working device and having a stationary stator and a rotor mounted movably thereto. The method comprises the steps:
1. Detecting the position of the rotor; and
2. Operating at least one coil of a coil arrangement based on the detected position of the rotor with an excitation current to move the rotor to a new position.

In an exemplary embodiment, detecting the position of the rotor comprises the following steps:
1a) Measuring a signal induced by the rotary motion of the rotor,
1b) Calculating the rotor position based on the signal and preferably
1c) Storing, in particular counting, of the signal, a reference value or the position of the rotor and preferably
1d) Calculating the angle covered by the rotor over a given period of time, in particular the revolutions covered.

A fourth aspect of the present disclosure relates to a method for operating a packaging material provision apparatus, in which packaging material, such as a paper cushioning material strand or a corrugated board web section, is provided by manipulating, in particular deforming and/or conveying, a fiber starting material, such as a single-ply or multi-ply paper web or a corrugated board web, wherein the packaging material provision device has at least one working device to be driven mechanically and at least one electric motor driving the working device, wherein at least one electric motor-own sub-controller controls and/or regulates the electric motor and a higher-level controller exchanges data with the electric motor-own sub-controller via a communication link by means of BUS technology, such as CAN-BUS technology. In an exemplary embodiment, the electric motor-own sub-controller controls the electric motor using the method according to the third aspect of the present disclosure.

A fifth aspect of the present disclosure relates to a method of operating a packaging material provision apparatus in which packaging material, such as a paper cushioning material strand or a corrugated board web section, is provided by manipulating, in particular deforming and/or conveying, a fiber starting material, such as a single or multi-ply paper web or a corrugated board web. According to the fifth aspect of the present disclosure, the manipulation is initiated by actuating the manipulated packaging material in the output area of the packaging material provision apparatus. In particular, the fifth aspect of the present disclosure may relate to a method of operating an apparatus according to the first and/or second aspect of the present disclosure. Alternatively, or additionally, the fifth aspect of the present disclosure may relate to a method of operating a packaging material provision apparatus, wherein operating the packaging material provision apparatus is in accordance with the third and/or fourth aspect of the present disclosure, while initiating the manipulation is in accordance with the fifth aspect of the present disclosure.

In an exemplary embodiment, the manipulated packaging material is actuated by an operator who operates the apparatus. Output area particularly means the area of the packaging material provision apparatus in which the packaging material can be actuated, in particular gripped, by an operator. The output area may, for example, extend entirely within the packaging material provision apparatus, in that it is configured to be large enough to ensure that the manipulated packaging material can be actuated by an operator within the apparatus. Alternatively, the output area may extend both inside and outside the apparatus. In this case, the output area outside the device is preferably designed, in particular freely accessible, in such a way that an operator can actuate, in particular gripped, the manipulated packaging material. In an exemplary embodiment, in this embodiment, the output area inside the device is designed in such a way that gripping by an operator into the inside of the device is made more difficult, in particular avoided. Such a design can in particular avoid the risk of injury to the operator.

Manipulated packaging material particularly means packaging material that has already been provided as packaging material by manipulation of the fiber starting material. In an exemplary embodiment, the manipulated packaging material itself has been provided by the method of operating a packaging material provision apparatus according to the disclosure. However, this is not absolutely necessary. The manipulated packaging material can, for example, also be provided by a known method in which, for example, the manipulation is initiated by actuating a switch on the packaging material provision device. However, it is in particular essential that the actuation of the already manipulated packaging material initiates the manipulation of fiber starting material by which additional packaging material is provided.

In an exemplary embodiment, the provision of the packaging material is initiated only when the apparatus is at a standstill. In particular, the device is at standstill when it is not manipulating any fiber starting material. A stand-by mode in which the device is waiting for the initiation of the provision of packaging material can preferably also be referred to as a standstill.

In an exemplary embodiment, the output area of the device is designed in such a way that gripping into the device is avoided, while the output area outside the apparatus allows actuation, in particular gripping, by an operator. By avoiding gripping into the apparatus, the risk of injury to the operator in can in particular be reduced.

In an exemplary embodiment, the actuation is performed by moving the manipulated packaging material and the initiation is preferably performed by detecting the movement, in particular with a sensor associated with the output area, such as a light sensor. In an exemplary embodiment, the sensor is for this purpose directed towards the output area of the apparatus in such a way that a movement of the packaging material is detected by the sensor. In one embodiment, for example, a sensor can be used that detects whether or not packaging material is present in the output area or a portion thereof. If there is no material in the output area, the sensor can transmit a corresponding signal to a controller, which then initiates the provision of packaging material. Alternatively, a sensor can be used that detects relative movement of the packaging material in the output area and transmits this to a controller. In this embodiment, the controller can be given a predefined path which, if exceeded, initiates the provision of packaging material and/or, if undershot, does not initiate any provision.

Alternatively, or additionally, the actuation can be performed by communicating an actuation force to the manipulated packaging material. In an exemplary embodiment, the actuating force is applied by pulling on the manipulated packaging material, in particular with a force of 5 Newton to 100 Newton, 10 Newton to 75 Newton, or 20 Newton to 50 Newton. Alternatively, or additionally, the actuating force may be applied over a distance over which the packaging material is moved as a result of the force, such as over at least 2 mm, 5 mm, 10 mm, 20 mm, 30 mm, or 50 mm. The force and/or the path over which the actuating force is communicated to the packaging material is preferably predetermined, in particular stored in a controller which, when the manipulated packaging material is actuated, interrogates whether the predetermined force and/or the predetermined path has been detected. If the predetermined force and/or the predetermined distance is reached, the controller preferably initiates the provision of the packaging material, whereas the provision preferably does not take place if the predetermined force and/or the predetermined distance is not reached. In this way, in particular, an unintentional initiation of the provision of packaging material, for example as a result of accidental actuation by an operator, can be substantially avoided.

In an exemplary embodiment of the present disclosure, the manipulated packaging material is in engagement with the packaging material provision apparatus at the beginning of the actuation, in particular in engagement with a manipulation device, such as a conveyor device or a deformation device. The engagement preferably comprises holding the manipulated packaging material with a holding force, wherein the holding force is preferably at least 10 Newton, 50 Newton, 100 Newton, 150 Newton, 250 Newton, 350 Newton, 450 Newton, 550 Newton, 700 Newton or 900 Newton.

The manipulation device may comprise a conveyor device, such as a pair of conveyor wheels or a single conveyor wheel. In an embodiment in which the manipulation device is substantially formed by the conveyor device, the manipulation of the fiber starting material particularly comprises conveying a predetermined length of the fiber starting material to the output area of the packaging material provision apparatus, thereby providing it. The embodiment of a manipulation device in the form of a deformation device may be realized, for example, by combining a conveyor device and a deformation funnel. In this case, the deformation is performed in particular by drawing, in particular with the conveyor device, the fiber starting material into the deformation funnel by means of the conveyor device.

In an exemplary embodiment, the holding force is applied via the conveyor device. For example, the holding force can be provided by clamping forces between the packaging material and the conveyor device. For this purpose, for example, a conveyor wheel can be preloaded against a wall in such a way that a holding force, in particular a predetermined holding force, acts on the manipulated packaging material. Particularly preferably, the holding force is realized by bracing two conveyor wheels of a pair of conveyor wheels.

In an exemplary embodiment of the present disclosure, the actuation is performed by an operator who preferably manually actuates, in particular grips, the manipulated packaging material. Alternatively, or additionally, the actuation is performed on a portion of the manipulated packaging material protruding from the packaging material provision apparatus. Particularly preferably, a section of the manipulated packaging material in the output area of the apparatus protrudes by at least 5 cm, 10 cm, 20 cm, 30 cm, 40 cm or 50 cm, so that preferably an operator can grip the packaging material without coming into contact with possibly sharp edges of the apparatus.

In one embodiment of the present disclosure, the manipulation comprises deforming a single-ply or multi-ply paper web, in particular of recycled paper, into a paper cushioning strand. For this purpose, a single-layer or multi-ply paper web is preferably drawn into a deformation device, such as a deformation funnel, in particular via a conveyor device, such as a pair of conveyor wheels, wherein the single-layer or multi-ply paper web is formed into a three-dimensional strand, in particular a paper cushioning strand. Subsequently, a paper cushioning product can be separated from the paper cushioning strand, in particular via a separation device. Alternatively, or additionally, the paper cushioning strand may be tensioned, in particular between two conveyor devices, such as two pairs of conveyor wheels. Tensioning can be a step upstream of separating, or can itself be used for separating, by tensioning the packaging material to such an extent that it is separated by tearing. Alternatively, or additionally, the manipulation may comprise conveying a corrugated board web section, in particular of predetermined length, from a corrugated board web. Thereby, preferably, a predetermined length of corrugated board web is conveyed, in particular from a fanfold stack, and provided to an operator via the output area of the apparatus.

In one embodiment of the present disclosure, the manipulating comprises separating a paper cushioning product, particularly of predetermined length, from a paper cushioning strand, the manipulating further preferably comprising deforming a single-ply or multi-ply paper web into the paper cushioning strand preceding the separating. Alternatively, or additionally, the manipulating comprises separating a corrugated board web section, particularly of predetermined length, from a corrugated board web, the manipulating further preferably comprising conveying the corrugated board web section from the corrugated board web preceding the separating.

In an exemplary embodiment, the actuation of the manipulated packaging material causes a rotary motion of a rotor, in particular of an electric motor driving a working device, such as a conveyor or a deformation device. In this case, the initiation preferably takes place by detecting the rotary motion of the rotor, in particular with a device for detecting the position of the rotor. Particularly preferably, the actuation of the manipulated packaging material causes in particular a rotational movement of the rotor by a predetermined minimum angle of 10° to 60°, 20° to 50° or 30° to 40°. In particular, as described in connection with the first aspect of the present disclosure, the rotational movement of the rotor may be detected by a sensor arrangement that is simultaneously used to operate a coil arrangement of the rotor or stator to which an excitation current is applied. Further, in particular as described in connection with the first aspect of the present disclosure, the rotational movement of the rotor can be performed by evaluating signals induced by the rotational movement of the rotor in a coil arrangement supplied with an excitation current. In an exemplary embodiment, when a signal induced by the rotary motion of the rotor is detected, it is interrogated whether an excitation current is applied to the coil arrangement. If this is not the case, the provision of packaging material is preferably initiated. In an exemplary embodiment, the initiation is effected by communicating the actuation of the packaging material, in particular the resulting rotary motion of the rotor and, if applicable, the information that an excitation current is not applied to the coil arrangement, to a higher-level controller, whereupon the higher-level controller preferably operates at least one, particularly preferably two or three, sub-controllers, such as electric motor-own controllers, for the provision by manipulation.

In an exemplary embodiment, prior to initiating the manipulation of the fiber starting material, the manipulated, actuated packaging material is separated from the fiber starting material, such as a single-ply or multi-ply paper web or a corrugated board web, or from a paper cushioning strand formed from a single-ply or multi-ply paper web, and/or conveyed out of the packaging material provision apparatus device. In particular, this can reduce the risk of packaging material blockage.

The method described in connection with the fifth aspect of the present disclosure is, in particular, a method for operating a packaging material provision apparatus comprising at least one working device to be driven mechanically and at least one electric motor driving the working device. In particular, the packaging material provision apparatus has at least one electric motor-own sub-controller which controls and/or regulates the at least one electric motor. Alternatively, or additionally, the packaging material provision apparatus comprises a controller, in particular a higher-level controller, which controls the manipulation of the fiber starting material. In particular, after initiation of the manipulation, the manipulation is controlled semi-automatically, in particular fully automatically, by the controller. In particular, after the manipulated packaging material (a first packaging material) has been actuated, the actuated packaging material can be dispensed from the apparatus. Thereupon, in particular, a second packaging material can be produced in particular by driving at least one electrically driven working device. Thereupon, the second packaging material can be provided in particular in the output area in such a way that the second packaging material can be actuated to initiate the provision of a third packaging material. By a semi-automatic manipulation, it is to be understood in particular that one or more of these steps and/or one or more of the steps described before or below are controlled by the controller. By a fully automatic manipulation it is to be understood in particular that, apart from the actuation, all of these steps and/or the steps described before or below are controlled by the controller. The use of fully automatic manipulation can in particular provide a method in which, as a result of an actuation of a packaging material that has already been manipulated, a further packaging material is provided fully automatically.

In particular, the methods described in connection with the third, fourth and/or fifth aspects of the present disclosure may be methods of operating an apparatus in accordance with the first and/or second aspects of the present disclosure. As described before and below, the manipulation of the fiber starting material may comprise, individually or in combination, both conveying, separating, and deforming the fiber starting material. In an exemplary embodiment, however, the manipulation comprises at least separating or deforming fiber starting material. In applications or embodiments in which the manipulation exclusively comprises conveying the fiber starting material, the conveying particularly comprises conveying the fiber starting material from a material web roll or from a packaging material stack. Particularly preferably, the method described in connection with the third, fourth and/or fifth aspect of the present disclosure relates to a method of operating a packaging material generating apparatus. In particular, by a packaging material generating apparatus is meant an apparatus in which the manipulation comprises at least one of deforming and/or separating the fiber starting material. In particular, the method described in connection with the third, fourth and/or fifth aspects of the present disclosure may relate to a method of operating a cushioning material generating apparatus. In particular, a cushioning material generating apparatus is understood to mean an apparatus in which the manipulation comprises a deformation operation in which a three-dimensional cushioning strand, in particular a three-dimensional paper cushioning strand, is generated from a single-ply or multi-ply web of starting material, in particular a single-ply or multi-ply paper web.

A sixth aspect of the present disclosure relates to a packaging material, such as a paper cushioning material strand or a corrugated board web section, produced by, in particular by means of, an apparatus according to the first and/or second aspect of the present disclosure. Alternatively, or additionally, the sixth aspect of the present disclosure relates to a packaging material produced according to a process according to the third, fourth and/or fifth aspect of the present disclosure.

In particular, when fiber starting material is referred to in the context of the present disclosure, it is an exemplary embodiment or application of the present disclosure. In an exemplary embodiment, both the devices according to the first and/or second aspect of the present disclosure and the methods according to the third, fourth and/or fifth aspect of the present disclosure can be used for manipulating starting material in general, i.e. for manipulating fiber starting material, for manipulating fiber-free starting material, such as plastic, and/or for manipulating composite material, such as combinations of fiber starting material and fiber-free starting material.

In particular, the method according to the disclosure according to the third, fourth and/or fifth aspect of the present disclosure may be designed to be carried out with the apparatus according to the disclosure according to the first and/or second aspect of the present disclosure.

In particular, the apparatus according to the disclosure according to the first and/or second aspect of the present disclosure may be structured such that the method according to the disclosure according to the third, fourth and/or fifth aspect of the present disclosure may be carried out.

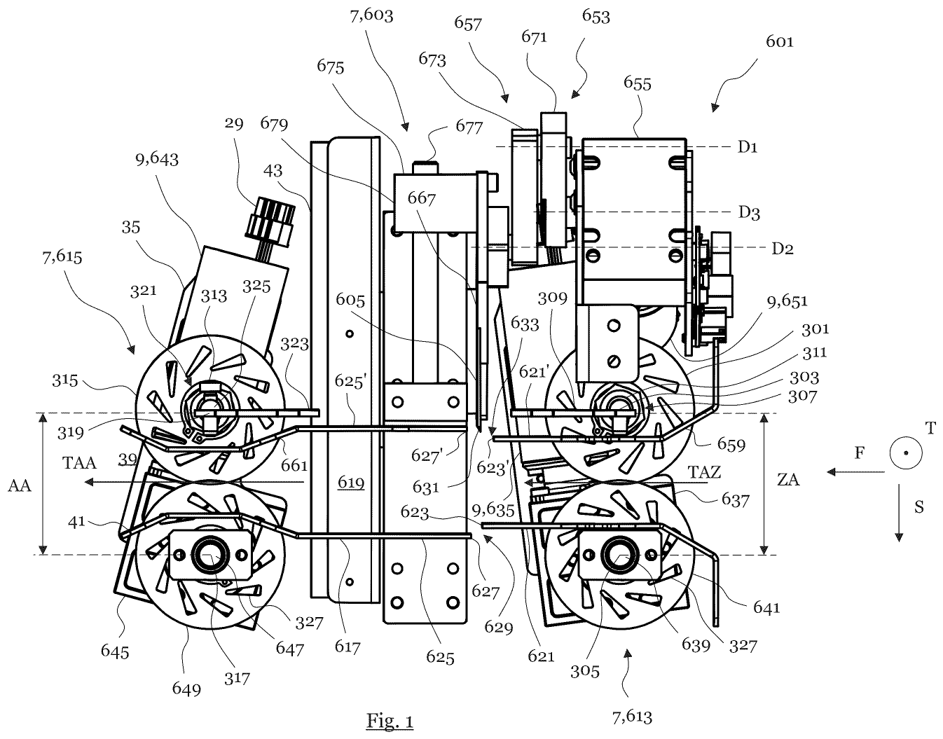

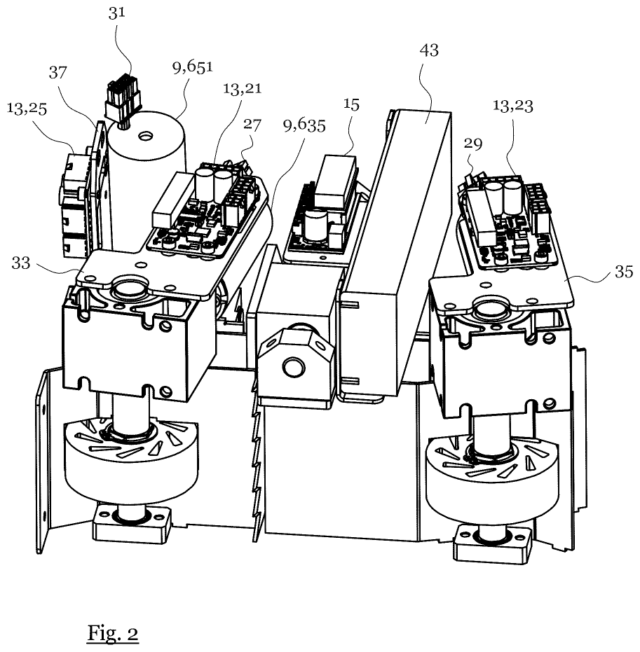

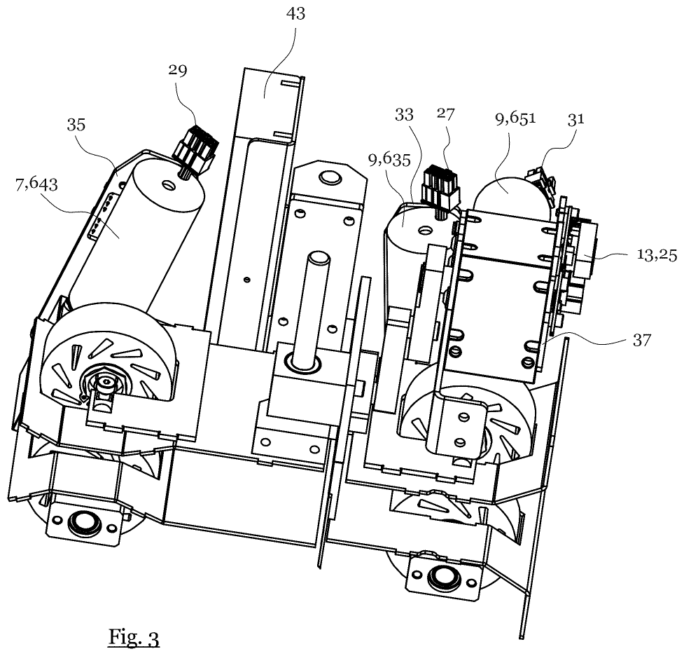

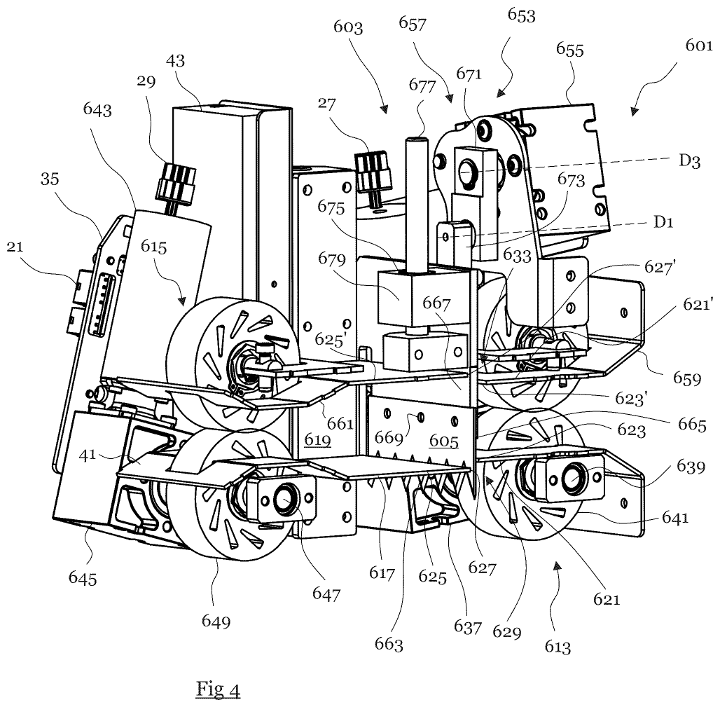

FIG. 1 shows a bottom view of an exemplary embodiment of an apparatus 601 for manufacturing packaging material products, in which a lower and upper boundary wall, in particular of the conveyor channel 619, is hidden to show the individual components of the device 601, wherein the blade 605 is in a cutting start position. FIGS. 2 to 4 each show perspective views of the apparatus 601, with the blade 605 in a cutting end position.

FIGS. 1 to 4 show an apparatus for providing packaging material in the form of paper cushioning products. For this purpose, a strand of packaging material in the form of a paper cushioning strand is fed to a first working device 7 in the form of a separating device 603. The feeding is performed by a second working device 7 in the form of a pair of feed wheels 613. The pair of feed wheels 613 is preferably further used to draw a fiber starting material 5 in the form of a single-layer or multi-layer paper web into a deformation device, in which the paper web is formed into a paper cushioning strand. For example, the paper web may be drawn from a paper web roll or a leporello stack. As a deformation device, for example, a deformation funnel (not shown) may be connected downstream in the conveying direction F to the apparatus 601, in particular to the pair of feed wheels 613. Alternatively, or additionally, the conveyor device 601 may have funnel-shaped sections 659, 661 deforming the fiber starting material. For example, as shown herein, funnel-shaped sections 659,661 may be provided in the conveying direction F upstream of the pair of feed wheels 613 and of the pair of discharge wheels 615 which are in the conveying direction F connected to the pairs of feed wheels 613, 615. Further, the apparatus 601 comprises a third working device 7 in the form of a pair of discharge wheels 615 arranged downstream of the separation device 603 in the conveying direction F. The pair of discharge wheels 615 is used, in particular, for discharging a paper cushioning product after it has been separated from the paper cushioning strand by the separation device 603. Alternatively, or additionally, the pair of discharge wheels 615 may cooperate with the pair of feed wheels 613 in such a way that the paper cushioning strand is tensioned prior to separation.

In the embodiment shown here, each of these three working devices is driven by a drive 635, 643 and 651. Preferably at least one, preferably two particularly preferably all three, of the drives 635, 643 and 651 is an electric motor 9 with a stationary stator, a rotor mounted movably thereto and a coil arrangement of the rotor or the stator to which an excitation current is applied, wherein the at least one electric motor 9 is free of an electrical contact coupling for transmitting the excitation current between the stator and the rotor and comprises a device 11 for detecting the position of the rotor. In the embodiment shown here, the device 11 for detecting the position of the rotor, the rotor, the stator and the coil arrangement are formed within the respective electric motor 635,643 and 651 and are therefore not shown in FIGS. 1 to 4. In particular, these are brushless DC motors with Hall sensors for the position detector.

Particularly preferably, at least one, preferably two, especially preferably all three, of the drives 635, 643 and 651 has an electric motor-own sub-controller 13. In FIGS. 1 to 3 shown here, the sub-controller 13 associated with the electric motor 635 driving the pair of feed wheels 613 is assigned the reference numeral 21. Reference numeral 23 is assigned to the sub-controller 13 associated with the electric motor 643 that drives the pair of discharge conveyor wheels 615. The sub-controller 13 associated with the electric motor 651 that drives the separation device 603 is associated with the reference 25. In an exemplary embodiment, according to the second aspect of the present disclosure, a higher-level controller 15 is provided for separating at least one, preferably two, more preferably all three, of the sub-controllers 21, 23 and 25. The communication link 17 according to the present disclosure for exchanging data between the at least one electric motor-own sub-controller 13 and the higher-level controller 15 using BUS technology is not shown in FIGS. 1 to 3. However, plugs 27, 29 and 31 are shown in each case, via which in particular the sub-controllers 21, 23, 25 can be connected to the communication link, in particular to a communication bus, such as a CAN bus. The sub-controllers 21, 23, 25 are respectively attached to the apparatus 601, in particular to the electric motors 635, 643,651, via mounting plates 33, 35, 37. The aforementioned ferritic shields are not shown in FIGS. 1 to 4, but can be attached to the sub-controllers 23, 25, 27, in particular via the mounting plates 33, 35, 37.

The output area is provided with the reference 39 and extends in particular from the pair of discharge wheels 615 in the conveying direction F beyond the apparatus 601. The output area inside the device is in particular limited by an output funnel 41 widening in the conveying direction F. The output area outside the apparatus 601 is considered to be in particular the area up to 10 cm, 20 cm, 30 cm, 40 cm, 50 cm, 60 cm, 70 cm or 80 cm outside the apparatus 601 in particular outside the output funnel 41. This area is preferably free of machine parts to allow undisturbed gripping of the manipulated packaging material by an operator. Furthermore, a power supply 43 is preferably provided for supplying power to at least one of the controllers 15, 21, 23 and 25.

In an exemplary embodiment, the output of the drive 635 of the pair of feed wheels 613 is coupled to the feed wheel pair 613, in particular to a drive shaft 639 of a feed wheel, in particular of the driven feed wheel 641, via a gear 637, in particular a worm gear.

Conveying direction F preferably means the direction in which the packaging material strand is conveyed from the pair of feed wheels 613 to the pair of discharge wheels 615. In the preferred embodiment shown here, the packaging material strand is conveyed directly, i.e. without deflection thereof, from the pair of feed wheels 613 to the pair of discharge wheels 615. It should be understood, however, that in a less preferred embodiment the strand of packaging material may also be deflected between the pairs of conveyor wheels 613, 615. In a broader sense, therefore, conveying direction F is to be understood as the direction in which the strand of packaging material is conveyed upstream and downstream of the conveyor device, in particular of the blade 605. For example, in the case of a plurality of deflection devices between the pairs of conveying wheels 613, 615, the conveying direction F would be defined by the direction in which the strand of packaging material is conveyed by the deflection device proximate upstream to the blade 605 and the deflection device proximate downstream to the blade 605. In the foregoing and the following, indications of the arrangement in the conveying direction F upstream and downstream of the separation device, respectively the blade 605, the state of cutting in which the comes 605 comes into cutting engagement with the strand of packaging material is preferably always to be considered. Thus, in the preferred embodiment in which the blade 605 transverses translationally, a straight line extending along the cutting direction S can be considered as a reference for the upstream and downstream arrangement of components. In embodiments in which the blade moves translationally only in the cutting engagement or also moves purely rotationally, a line extending in the cutting direction S at the time of the cutting engagement is to be considered for assessing the upstream and downstream positioning of components with respect to the blade 605. The cutting direction S is the direction in which the blade 605 enters the packaging material strand during cutting engagement therewith. In the case of a purely rotationally guided blade 605, the tangent in the cutting engagement would therefore have to be considered as the cutting direction S.

The pair of discharge wheels is driven by its own drive 643, in particular an electric motor. The output of the drive 643 is coupled to the pair of discharge wheels 615, in particular to a drive shaft 647 of a driven discharge wheel 649, via a gear box 645.

The separation device 603 is driven by a drive 651, in particular in the form of an electric motor. In FIG. 1, the electric motor 651 of the separation device 603 extends in the drawing plane and in the cutting direction S. The output of the drive 651 of the separating device 603 is coupled to the separating device 603 via a gear box 653, in particular a separating device-own gear box. In the embodiment shown here, the gear box 653 of the separating device 603 comprises a transmission gear box 655 for elevation or reduction of the output movement of the drive 651. Furthermore, the separation device-own gear box 653 comprises a conversion gear box 657 for converting a rotary movement into a translatory movement, in particular in the cutting direction S.

In an exemplary embodiment, the blade 605 has multiple cutting teeth 663. In an exemplary embodiment, the blade 605 has seven cutting teeth 663. The cutting teeth adjoin one another in particular in a direction transverse to the conveying direction F, in particular orthogonal thereto, and transverse to the cutting direction S, in particular orthogonal thereto. Thereby, the cutting teeth can extend over the entire depth T of the blade 605. In the drawings, the depth T of the paper cushioning product machine is the direction pointing out of the drawing plane. The depth T preferably extends transversely, in particular orthogonally, to the cutting direction S and to the conveying direction F.

Particularly preferably, the cutting teeth 663 extend substantially over the entire depth T of the conveyor channel 619. By the entire depth T, it is not to be understood that the blade 605 rubs along the upper and lower boundary walls, which are not shown. Rather, a corresponding gap is preferably provided in the transition region between the upper and lower boundary walls and the blade so that the blade 605 travels relative to the upper and lower boundary walls without contact. Cutting teeth 663 are preferably formed as triangles tapering in the cutting direction S, which preferably taper pyramid-shaped in the conveying direction F over the thickness of the blade. The cutting teeth adjoining the upper and lower boundary walls at depth T merge in the direction opposite to the cutting direction S, in particular in alignment, into a mounting section 665 of the blade 605. The blade 605 is connected, in particular screwed, via the mounting section 665 to a slide 667 of the separating device 603. For fastening the blade 605 to the slide 667, bores 669 are preferably provided in the mounting section 665 of the blade 605. Via the bores 669, the blade is preferably connected to the slide 667 of the blade by means of screws or rivets. The slide moves in particular in cutting direction S.

The conversion gear box 657 of the separating device 603 preferably comprises two joint sections 671, 673 connected to each other in a rotatable manner, in particular about an axis of rotation D1 extending in the conveying direction F. The joint sections 671, 673 are each preferably connected to each other via one end. One joint section 673 faces the carriage 667 in the conveying direction. The other drive 651 faces, in particular, the transmission gear box 655 of the drive 651. At its end facing away from the axis of rotation D1, the joint section 673 facing the slide 667 is articulated movably to the carriage 667 via an axis of rotation D2 extending in particular in the conveying direction F. The joint section 671 facing the drive 651, in particular the transmission gear box 655, is articulated to the transmission gear box 655 via an axis of rotation D3 extending in particular in the conveying direction F. Furthermore, the separating device 603 preferably comprises a guide 675 in the cutting direction S. The guide preferably comprises a cylinder 677 extending in particular in the cutting direction S and a slide shoe 679 movable along the cylinder 677 in the cutting direction S. The slide shoe 679 is preferably fixedly connected to the slide 667. Particularly preferably, the guide of the blade 605 is arranged downstream of the blade 605 in the conveying direction F and the gear box 653, in particular the conversion gear box 657, is arranged upstream of the blade 605 in the conveying direction F. In the embodiment shown, a transmission gear box 655 is provided between the axis of rotation D3 and the drive 651 for translating the drive rotary motion. In an exemplary embodiment, the transmission gear box 655 is a worm gear. Furthermore, the gear box 655 can additionally be designed to offset the rotational axis of the drive 651, in particular to offset it by 90° to the rotational axis D3.

In the conveying direction F at the level of the separation device 603, a conveyor channel 619 extends which is bordered by a boundary wall 617. In an exemplary embodiment, the conveyor channel 619 extends in the conveying direction upstream and downstream of the separating device up to the pair of feed wheels 613 and the pair of discharge wheels 615, preferably beyond the pairs of conveyor wheels. A slit 629 is configured in the boundary wall 617 such that the blade 605 can enter and exit the slit 629 without contact.

As previously described, the conveyor channel 619 is bordered in the conveying direction F upstream of the slit 629 by an upstream wall section 621 and downstream of the slit 629 by a downstream wall section 625. When reference is made previously or subsequently to passing through the conveyor channel 619 in the cutting direction S, this is to be understood to mean in particular that the blade passes through the section of the conveyor channel 619 bordered by the upstream wall section 621. In particular, in the cutting start position, the blade is to be located in cutting direction S outside the conveyor channel 619, in order to avoid that the packaging material strand 611 gets caught on the blade 605, in particular on the cutting tip 631, when being conveyed between the pairs of conveyor wheels 613, 615.

Before the packaging material product is separated from the packaging material strand, the packaging material strand extends between the pairs of conveyor wheels 613, 615. The blade 605 preferably travels through the conveyor channel 619 in a purely translatory manner. In particular, the blade 605 thereby travels transversely, preferably orthogonally, to the conveying direction. In an exemplary embodiment, the apparatus is oriented in such a way that the blade 605 traverses the conveyor channel 619 horizontally. By passing through, it is to be understood in particular that the blade, during a movement from the cutting start position to the cutting end position, enters the conveyor channel 619 from one side in cutting direction S and leaving the conveyor channel 619 via the opposite side in cutting direction S. Entering into the conveyor channel 619 particularly takes place via a retraction slit 633, which is introduced in the boundary wall 617. Leaving the conveyor channel 619 particularly takes place via a slit 629, which is provided in the boundary wall 617.

In an exemplary embodiment, the boundary wall 617 has a funnel-shaped section 659, 661 upstream of the pair of feed wheels 613 and/or of the pair of discharge wheels 615 in the conveying direction F, which tapers in the conveying direction F. In an exemplary embodiment, the tapering of the funnel-shaped section 659, 661 occurs in the cutting direction S. Alternatively or additionally, the tapering may be formed in a direction orthogonal to the conveying direction and the cutting direction. The funnel-shaped section 659, 661 can be round or angular. In the embodiment shown here, the funnel-shaped section is angular and tapers in the cutting direction S only. The tapering of the conveyor channel 619 is preferably formed in the region of the conveyor channel 619 in which the packaging material strand 619 engages the pair of feed wheel 613 and/or the pair of discharge wheels 615. The tapering of the conveyor channel 619 can, on the one hand, increase the degree of deformation from the substantially two-dimensional paper web into the three-dimensional packaging material strand and can facilitate the engagement with the pairs of conveyor wheels 613, 615.

The device 601 has a conveyor channel 619 which is bordered by a boundary wall 617. Particularly preferably, the conveyor channel 619 extends in the conveying direction F at least between the two pairs of conveyor wheels 613, 615. In a less preferred embodiment, the conveyor channel extends at least at the conveying direction level of the separating device, respectively of the blade 605. Thereby, it is particularly important to border the conveyor channel 619 in particular immediately upstream and downstream of the blade 605. The conveyor channel 619 is bordered by a boundary wall 617. In the boundary wall 617, a slit 629 is configured in such a way that the blade 605 can move in and out of the gap 627 without contact. In the conveying direction F upstream of the slit 629, the conveyor channel is bordered by a wall section 621 having an upstream counter edge 623 bordering the slit in the conveyor direction F upstream. In the conveying direction downstream of the slit 629, the conveyor channel 619 is bordered by a downstream wall section 625 having a downstream counter edge 627 bordering the slit 629 in the conveying direction F downstream.

The device 601 can additionally have a retraction slit 633 formed in the boundary wall 617, which is designed in such a way that the blade can move in and out of the conveyor channel 619, in particular without contact. The retraction slit 633 is preferably formed on a section of the boundary wall 617 opposite the slit in the cutting direction S. Particularly preferably, the retraction slit 633 and/or the section of the boundary wall 617 opposite the slit 629 is formed like the slit 629 and/or like the wall sections surrounding the slit. This has in particular to be understood in that the conveyor channel 619 is bordered in the conveying direction F upstream of the retraction slit 633 by an upstream wall section 621′ which has an upstream counter edge 623′ bordering the retraction slit 633 in the conveying direction upstream. Alternatively, or additionally, this has to be understood in that the conveyor channel 619 is bordered in the conveying direction F downstream of the retraction slit 633 by a downstream wall section 625′ which has a downstream counter edge 627′ bordering the retraction slit 633 in the conveying direction F downstream. In an exemplary embodiment, while entering and leaving the slit, the blade 605 is spaced in conveying direction from the upstream counter edge 623′ and/or spaced from the downstream counter edge 627′.

In an exemplary embodiment, one of the feed wheels of the pair of feed wheels is not directly driven by the drive 635. The non-directly driven feed wheel 301 is preferably driven indirectly via the driven feed wheel 641. Particularly preferably, this is achieved by the non-driven feed wheel 301 being biased against the driven feed wheel 641. As can be seen in particular in FIGS. 1 to 4, the biasing is realized in particular by under sizing the distance between the wheel axles 303, 305. By under sizing the feed wheel axle distance ZA, the feed wheels are elastically biased against each other. To set the feed wheel axle distance ZA, at least one of the feed wheels 641, 301 can preferably be moved relative to the other feed wheel or clamped to it. In an exemplary embodiment, a bracing device 307 is provided for this purpose, with which one of the feed wheels 641, 301 can be clamped to the other feed wheel 301, 641 via wall sections of the apparatus 601. The bracing device preferably comprises a wheel mounting 309 connecting the feed wheel 301 to the lower and upper boundary walls, which are not shown, and at least one, preferably two, fastening means 313, such as a screw 313 (shown only for the pair of discharge wheels 615), connecting the wheel shaft 311 of the feed wheel 301 to the wheel mounting 309. As shown in FIG. 1, the bracing device 307 is preferably attached to the non-driven feed wheel 301. Thus, the feed wheel axis distance ZA can be adjusted, for example by actuating the fastening means 313, while the driven feed wheel 641 remains in a constant position relative to the drive 635. Thus, in particular the tension between the feed wheels can be adjusted, in particular depending on the fiber starting material to be processed or the desired packaging material product geometry, in particular without substantially increasing the development effort of the apparatus 601.

Alternatively, or additionally, the discharge wheels 649, 315 are braced against each other. Particularly preferably, the tension between the discharge wheels 315, 649 is set via an undersized discharge wheel axle distance AA between the wheel axle 317 of the driven discharge wheel 649 and the wheel axle 319 of the undriven discharge wheel 315. The discharge wheel axle distance AA can be adjusted by a bracing device 321 as described for the pair of feed wheels 613. The bracing device 321 of the pair of discharge wheels 615 preferably also comprises a wheel mounting 323 with which the wheel shaft 325 of a discharge wheel 315, 649 is fixed to the apparatus 601 and a connecting means 313 for connecting the wheel shaft 325 to the wheel mounting 323 of the bracing device 321.

An undersized wheel axle distance means in particular that the distance between the wheel axles 303, 305, 317, 319 of a pair of wheel is smaller than the sum of the radii of both wheels, in particular in the dismantled state. This can be ensured in particular by a certain elasticity of the conveyor wheels. Therefore, it is preferred to form the conveyor wheels from an elastomer body, such as a PU foam body, or to provide them with an elastically deformable rolling area on their outer circumference. The elasticity of the conveyor wheels can be further increased by the measure that a plurality of recesses 327, in particular between six and fourteen, are provided, in particular recesses 327 distributed uniformly in the circumferential direction. In order to ensure that the elasticity of the conveyor wheels is substantially independent of the rotational position, the recesses 327 are preferably introduced into the conveyor wheels uniformly in the circumferential direction.

The apparatus 601 illustrated in FIGS. 1 to 4 shows the state in which no packaging material strand is in engagement with the pairs of conveyor wheels 613, 615. In this state, the wheels of the pairs of conveyor wheels preferably contact each other by being mutually braced in a contact surface that is, in particular, circular or elliptical. If, on the other hand, the pairs of conveyor wheels 613, 615 are in engagement with the packaging material strand, the respective conveyor wheels are preferably separated from each other by the packaging material strand. In a less preferred embodiment, the conveyor wheels are merely in tangential contact with each other or are spaced apart from each other so that power transmission between the conveyor wheels of a pair of conveyor wheels 613, 615 does not occur until the packaging material strand is in engagement with the respective pair of conveyor wheels. In an exemplary embodiment, the wheel axles 317, 319 of the pair of discharge wheels and/or the wheel axles 303, 305 of the pair of feed wheels are aligned with respect to each other in such a way that the tangent TAZ of the pair of feed wheels and/or the tangent TAA of the pair of discharge wheels run parallel to the conveyor direction F. In this context, a tangent is in particular not to be understood exclusively as meaning that the conveyor wheels are merely tangent to each other; rather, in the preferred embodiment in which a contact surface is created between the conveyor wheels, a line extending in the conveying direction between the first contact point and the last contact point is also to be regarded as a tangent.

In less preferred embodiments, the wheel axles 303, 305, 317, 319 of a respective pair of wheels 615, 613 can be offset from one another in such a way that the tangent TAZ of the pair of feed wheels and/or the tangent TAA of the pair of discharge wheels are inclined relative to the conveying direction F. Particularly preferably, the wheel axles of a respective pair of feed wheels are arranged relative to each other in such a way that the tangents TAZ and TAA run parallel to each other and are particularly preferably identical. This can be achieved in particular by the wheel axles 303, 305, 317, 319 of a respective pair of wheels 613, 615 being arranged one above the other, in particular in cutting direction S.

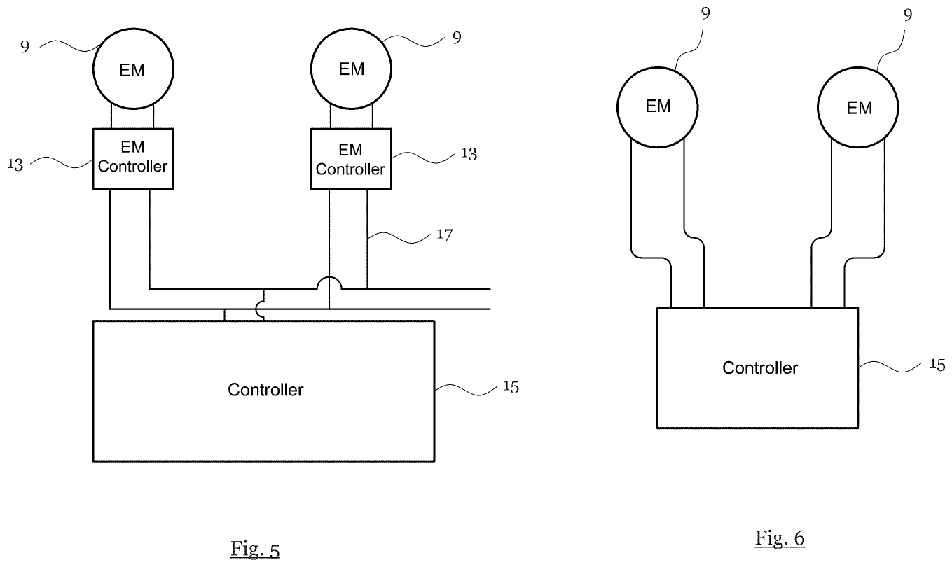

When comparing FIG. 5 and FIG. 6, a difference between the apparatus and the method according to the second and fourth aspects of the present disclosure becomes apparent. FIG. 6 shows the conventional operation of electric motors 9 via a controller 15. In this conventional embodiment, the controller 15 must be redesigned depending on the number and type of electric motors 9 to be controlled. This leads in particular to increased development costs, since the controller 15, especially when brushless DC motors are used, requires regulation of the motor. In contrast, the use of electric motor-own sub-controllers 13 can not only increase the flexibility of the apparatus 601, but also reduce the development costs of the apparatus 601, since the requirements on the higher-level controller 15 can be reduced by having the sub-controllers 13 taking over control and regulation tasks. In particular, the use of electric motor-own sub-controllers 13 makes the use of brushless DC motors particularly interesting, since the increased lifetime compared to brushed motors can be better exploited due to the flexibility with respect to the apparatus 601 in which the motors can be used.

FIG. 7 is a schematic representation of the communication between the higher-level controller 15, the electric motor-own sub-controller 13, the electric motor 9, the position detector 11 and the working device 7. In accordance with the first and third aspects of the present disclosure, FIG. 6 shows an electric motor 9 which can detect the position of the rotor of the electric motor 9 by means of a position detector 11, such as, for example, a sensor arrangement which has three Hall sensors each arranged offset by 120° with respect to one another. In an exemplary embodiment, signals, such as voltages, induced in the sensors by a rotary movement of the rotor are measured for this purpose and the position of the rotor is determined by evaluating the signals by means of an evaluation device, which is preferably implemented in the sub-controller 13. Depending on the determined rotor position, an excitation voltage is then alternately applied to a coil arrangement to cause the rotor to rotate. The rotor in turn drives the working device 7. As shown in FIG. 6, the provision of packaging material can be triggered by actuating a switch 19.

In accordance with the second and fourth aspects of the present disclosure, there is provided in FIG. 7 an electric motor-own sub-controller 13 for controlling and/or regulating an electric motor 9 driving a working device 7. Further, a higher-level controller 15 is provided for operating the sub-controller 13. To initiate the provision of packaging material 3, in particular by manipulating a fiber starting material 5, the switch 19 can be actuated as shown in FIG. 6. Thereupon, the higher-level controller 15 operates the electric motor-own sub-controller 13, which in turn controls and/or regulates the electric motor.

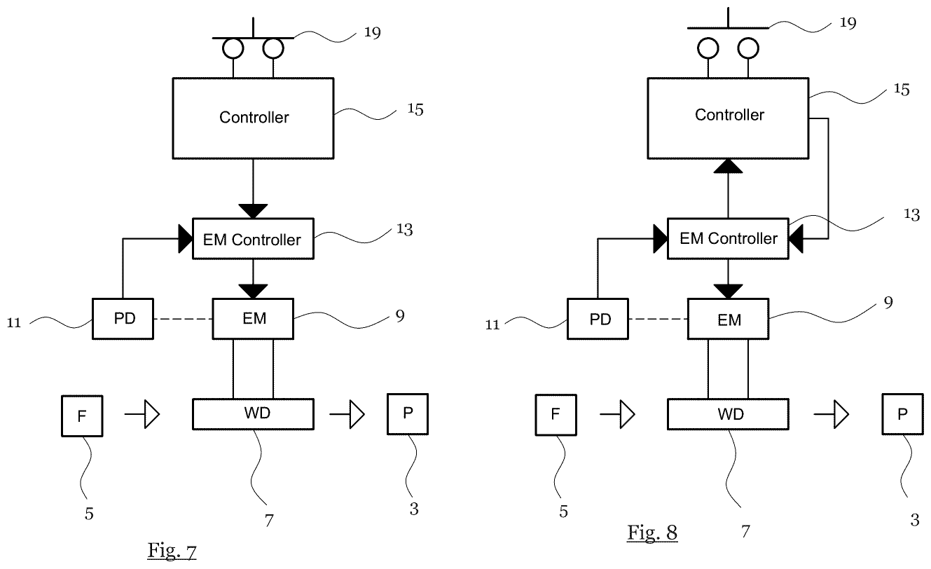

FIG. 8 shows essentially the schematic representation of FIG. 7, with the difference that here the provision of packaging material 3 is initiated without actuating the switch 19. For this purpose, a method according to the fifth aspect of the present disclosure is used, according to which the provision of in particular additional packaging material 3 by manipulation of fiber starting material 5 is initiated by actuation of in particular already manipulated packaging material 3. Thereby, in particular by actuating the manipulated packaging material 3, the working device 7, in particular a conveyor wheel 649 of a pair of discharge wheels 615, as shown for example in FIGS. 1 to 4, is subjected to a rotary motion. This is realized in particular by the fact that the manipulated packaging material 3 is still in engagement with the conveyor wheels 649 and 315, which are braced against each other, so that by pulling on the packaging material 3 the conveyor wheels 649,315 of the pair of discharge wheels 615 are set in rotation. Due to the mechanical coupling of the working device in the form of the driven discharge wheel 649 with the electric motor 9, 643, the rotor of the electric motor 9, 643 is subjected to a rotary motion. This rotary motion is detected by the position detector 11 and transmitted to the electric motor-own sub-controller 13. Thereupon, the electric motor-own sub-controller 13 transmits a trigger signal to the higher-level controller 15, whereupon the controller 15 operates the electric motor-own sub-controller 13 to provide packaging material 3 by manipulating fiber starting material 5.

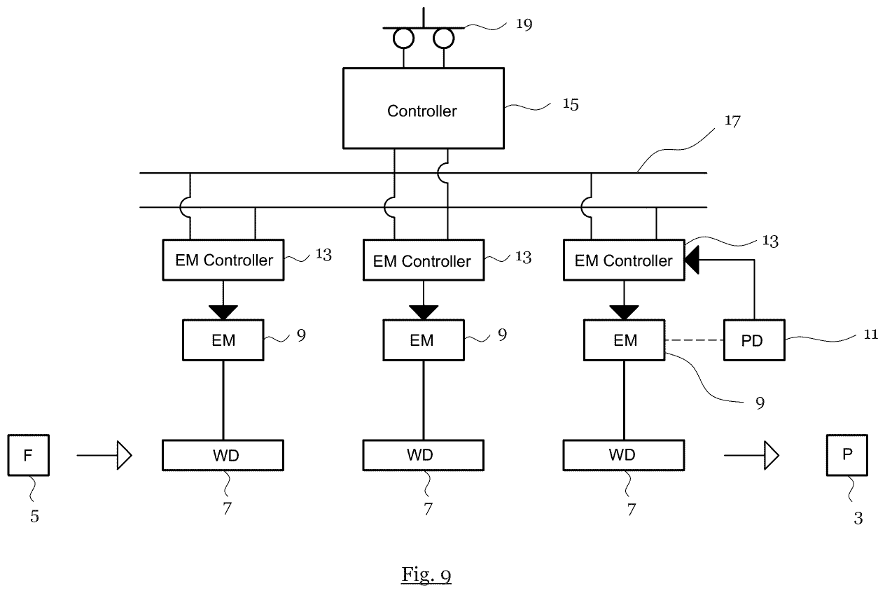

FIG. 9 shows a schematic representation of three working devices 7, each of which is driven by an electric motor 9, which in turn is controlled and/or regulated in each case by an electric motor-own sub-controller 13. The three electric motor-own sub-controllers 13 are controlled by a higher-level controller 15. The higher-level controller 15 and the electric motor-own sub-controllers 13 are interconnected via a communication link 17 for data exchange. Such an Interconnection of the individual units could be used in particular to operate an apparatus as shown in FIGS. 1 to 4. In this regard, the previously described provision of packaging material 3 can be performed by manipulating fiber starting material 5 by actuating the switch 19, or by actuating manipulated packaging material 3 in the output area 39 of apparatus 601, particularly in accordance with the fifth aspect of the present disclosure.

The features disclosed in the foregoing description, figures, and claims may be significant, both individually and in any combination, for the realization of the disclosure in the various embodiments.

### REFERENCE LIST

3 Packaging material
5 Fiber starting material
7 Working device
9 Electric motor
11 Position sensing device (sensor)
13 electric motor-own sub-controller
15 Higher-level controller
17 Communication link
19 Switch
21 Sub-controller of the pair of feed wheels
23 Sub-controller of the pair of discharge wheels
25 Sub-controller of separating device
27 plug of the sub-controllers of the pair of feed wheels
29 plug of the sub-controller of the pair of discharge wheels
31 plug of the sub-controller of the separating device
33 Mounting plate for the sub-controller 21
35 Mounting plate for the sub-controller 23
37 Mounting plate for the sub-controller 25
39 Output area
41 Output funnel
43 Power supply unit
301 Undriven feed wheel
303 Wheel axle of the undriven feed wheel
305 Wheel axle of the driven feed wheel
307 Bracing device of the feed wheel pair
309 Wheel mounting of the bracing device 307
311 Wheel shaft of non-driven feed wheel 301
313 Connecting means of the clamping device
315 Undriven discharge wheel
317 Wheel axle of the driven discharge wheel
319 Wheel axle of the non-driven discharge wheel
321 Bracing device of the pair of discharge wheels
323 Wheel mounting of the bracing device 321
325 Wheel shaft of the non-driven discharge wheel
327 Recess in conveyor wheel
601 Apparatus
603 Cutting device (cutter)
605 blade
613 Pair of feed wheels
615 Pair of discharge wheels
617 Boundary wall
619 Conveyor channel
621, 621′ upstream wall section
623,623′ upstream counter edge
625,625′ downstream wall section
627,627′ downstream counter edge
629 Slit
631 Cutting tip
633 Retraction slit
635 Drive, electric motor of the pair of feed wheels
637 Gearbox of the pair of feed wheels
639 Drive shaft of the driven pair of feed wheels
641 Driven feed wheel
643 Drive, electric motor of the pair of discharge wheels
645 Gearbox of the pair of discharge wheels
647 Drive shaft of the pair of driven discharge wheels
649 Driven discharge wheel
651 Drive, electric motor of the separating device
653 Gearbox of the separating device
655 Transmission gearbox
657 Conversion gearbox
659 funnel-shaped section of the pair of feed wheels
661 Funnel-shaped section of the pair of discharge wheels
663 Cutting teeth
665 Mounting section of the blade
667 slide of the blade
669 Bores in blade
671 Joint section (facing the transmission gearbox 655)
673 Joint section (facing the slide 667)
675 Blade guide in cutting direction
677 Guide cylinder
679 Slide shoe
T Depth of the paper cushioning product machine
F Conveying direction
S Cutting direction
AA Discharge wheel axis distance
ZA Feed wheel axis distance
TAZ Tangent of the pair of feed wheels
TAA Tangent of the pair of discharge wheels
D1 Axis of rotation between the two joint sections 671 and 673
D2 Axis of rotation between the joint section 673 and the carriage 667
D3 Axis of rotation between the joint section 671 and the transmission gearbox 655

1. A method for operating a packaging material provision apparatus, in which packaging material is provided by manipulating a fiber starting material, the method comprising:
detecting a position of a rotor of an electric motor of the packaging material provision apparatus, wherein the packaging material provision apparatus further includes at least one working device drivable by the electric motor, the electric motor including a stationary stator and the rotor that is movable supported with respect thereto; and
operating at least one coil of a coil arrangement, based on the detected position of the rotor, with an excitation current to move the rotor to a new position.

2. The method according to claim 1, wherein detecting the position of the rotor comprises:
measuring a signal induced by a rotary motion of the rotor;
calculating the rotor position based on the signal;
storing the position of the rotor; and
calculating an angle covered by the rotor over a period of time.

3. The method according to claim 1, further comprising:
controlling and/or regulating the electric motor, using a motor controller; and
exchanging data between the motor controller and a higher-level controller via a communication link.

4. The method according to claim 1, further comprising manipulating the fiber starting material in an output area of the packaging material provision apparatus to provide the packaging material.

5. The method according to claim 4, further comprising
moving the manipulated packaging material to actuate the manipulated packaging material; and
detecting a movement of the manipulated packaging material with a sensor associated with the output area.

6. The method according to claim 5, wherein the actuation includes imparting an actuating force to the manipulated packaging material by pulling on the manipulated packaging material with a predetermined force and/or over a predetermined distance.

7. The method according to claim 4, wherein the manipulated packaging material is brought into engagement with the packaging material provision apparatus, the engagement including holding the manipulated packaging material with a holding force.

8. The method according to claim 5, wherein the actuation is a manual actuation that includes gripping the manipulated packaging material, and/or the actuation is carried out at a region of the manipulated packaging material protruding from the packaging material provision apparatus.

9. The method according to claim 4, wherein the manipulation comprises:
deforming a single-ply or multi-ply paper web into a paper cushioning strand; and/or
conveying a corrugated board web section of a corrugated board web.

10. The method according to claim 4, wherein the manipulation comprises separating:
a paper cushioning product from a paper cushioning strand, the manipulation further including deforming a single-ply or multi-ply paper web into the paper cushioning strand preceding the separating; and/or
a corrugated board web section from a corrugated board web, the manipulation further including conveying a corrugated board web section of a corrugated board web preceding the separating.

11. The method according to claim 5, wherein the actuation of the manipulated packaging material causes a rotary movement of the rotor of the electric motor and the manipulation of the fiber starting material is initiated in response to the detecting of the rotary movement of the rotor.

12. The method according to claim 4, wherein before initiating the manipulation of the fiber starting material, the manipulated, actuated packaging material is separated from the fiber starting material and/or conveyed out of the packaging material provision apparatus.

13. An apparatus for providing packaging material by manipulating a fiber starting material, the apparatus comprising:
a working device configured to be driven mechanically to manipulate the fiber starting material;
an electric motor configured to drive the working device, the electric motor including a stationary stator, a rotor mounted movably thereto, a coil arrangement of the rotor or of the stator to which an excitation current is applied, and a position detector comprising an electromagnetic sensor configured to detect a position of the rotor; and
a controller configured to:
detect a manually-induced rotary motion of rotor based on the detected position of the rotor by the position detector, the manually-induced rotary motion of rotor being based on a manually-induced rotary motion of the working device transferred to the rotor by a mechanically coupling of the working device with the rotor; and
control the electric motor to drive the working device based on the detected manually-induced rotary motion of rotor.

14. The apparatus according to claim 13, wherein the manually-induced rotary motion of the working device is based on a manual force applied to the packaging material engaged with the working device.

15. The apparatus according to claim 14, wherein the working device comprises a pair of conveyor wheels, the packaging material being engaged with the conveyor wheels, and the manually-induced rotary motion of the working device including a manually-induced rotary motion of the conveyor wheels.

16. The apparatus according to claim 14, wherein the manual force applied to the packaging material engaged with the working device comprises a pulling force applied to the packaging material by a user pulling the packaging material out of the working device.

17. The apparatus according to claim 16, wherein the working device comprises a pair of conveyor wheels, the packaging material being engaged with the conveyor wheels, and the packaging material being pulled out of the conveyor wheels by the pulling force.

18. The apparatus according to claim 14, wherein the manually-induced rotary motion of the working device begins with conveyor wheels of the working device being in a stationary position.

19. The apparatus according to claim 13, wherein the working device comprises a pair of deformation wheels, a pair of conveyor wheels, or a rotary cutter or a translational cutter.
